(19) United States
(12) Patent Application Publication
(10) Pub. No.: US 2010/0196244 A1
(43) Pub. Date: Aug. 5, 2010

(54) METHOD AND DEVICE FOR BINDING GASEOUS CO2 TO SEA WATER FOR THE FLUE GAS TREATMENT WITH SODIUM CARBONATE COMPOUNDS

(75) Inventors: Peter Grauer, Meggen (CH); Florian Krass, Weggis (CH)

Correspondence Address: DUANE MORRIS LLP - (prev. San Francisco);IP DEPARTMENT, 30 SOUTH 17TH STREET, PHILADELPHIA, PA, 19103-4196, US

(73) Assignee: Silicon Fire AG, Meggen (CH)

(21) Appl. No.: 12/531,489

(22) PCT Filed: Jan. 30, 2008
(86) PCT No.: PCT/EP08/51097

§ 371 Date: Mar. 31, 2010

(30) Foreign Application Priority Data
Mar. 15, 2007 (EP) 07104246.9
Apr. 27, 2007 (EP) 07107134.4

(51) Int. Cl. C01D 7/10; B01J 19/00; C01D 7/18

(52) U.S. Cl. 423/423; 422/187; 423/421

(57) ABSTRACT

Method for binding gaseous CO₂ to a concentrated salt brine being produced from sea water by supplying energy. Ammonia (NH₃) and the CO₂ to be bound are then introduced into the concentrated ammonia salt brine. Sodium carbonate, preferably sodium hydrogen carbonate (NaHCO₃) is produced and may be removed from the ammonia-containing brine.

### CROSS-REFERENCES TO RELATED APPLICATIONS

The present application claims the priorities of the Patent Cooperation Treaty Application No. PCT/EP2008/051097, as filed on Jan. 30, 2008; and

European Patent Application No. EP 07 107 134.4, as filed on Apr. 27, 2007; and

European Patent Application No. EP 07 104 246.9, as filed on Mar. 15, 2007, which are all incorporated herein by reference in their entirety for all purposes.

### BACKGROUND OF THE INVENTION

Method and device for binding gaseous CO₂ to sea water for the flue gas treatment with sodium carbonate compounds.

The present application claims the priorities of
the Patent Application EP 07 104 246.9, which was filed with the EPO on 15 Mar. 2007, and
the Patent Application 07 107 134.4, which was filed with the EPO on 27 Apr. 2007.

The present application concerns methods and devices for binding gaseous CO₂. Preferably the invention is employed in connection with sea water desalination, energy production or industrial processes.

Carbon dioxide is a chemical compound of carbon and oxygen. Carbon dioxide is a colorless and odorless gas. At low concentration, it is a natural component of air and arises in living organisms during cell respiration, but also during the combustion of carbonaceous substances with sufficient oxygen. Since the beginning of industrialization, the CO₂ component in the atmosphere has significantly increased. The main reasons for this are the CO₂ emissions caused by humans—known as anthropogenic CO₂ emissions.

The carbon dioxide in the atmosphere absorbs a part of the thermal radiation. This property makes carbon dioxide into a greenhouse gas and is one of the causes of the greenhouse effect.

For these and also other reasons, research and development is currently being performed in greatly varying directions to find a way of reducing the anthropogenic CO₂ emissions. There is a great need for CO₂ reduction in particular in connection with energy production, which is frequently performed by the combustion of fossil energy carriers, such as coal or gas, but also in other combustion processes, for example, during garbage combustion. Billions of tons of CO₂ are released into the atmosphere every year by such processes.

A further problem is currently building up due to the increase of sea water desalination plants. The faun of sea water desalination used up to this point results in an increased strain of the ocean with salt loads, which flow back into the ocean as drinking water is obtained. Together with global climate warming and the increase of evaporation, the salt content of the Persian Gulf, for example, is increasing in the medium term and the operation of the plants for sea water desalination is thus going to get more expensive. In addition, the sensitive biological environments are disturbed when the salt concentration changes.

Combining desalination plants with plants for salt production so that no salt concentrate has to be pumped back into the ocean is viewed more and more as a solution. However, this path does not appear to be cost-effective, because the outlay for transportation to transport the salt thus obtained to the correct geographic location is large.

A further disadvantage is that energy is the largest cost factor when obtaining drinking water from salty sea water. If the plant for obtaining energy is coupled to a typical power plant, the required energy may be provided by the power plant. However, environmentally-harmful materials arise in the power plant, such as CO₂, which enter the air with the flue gas.

In the following, the so-called ammonia-soda method (Solvay method), which is over 100 years old, is explained, because this method is currently viewed as the closest prior art to the present invention, although the stated object of the present invention is different, as will be explained later. The Solvay method starts from the raw materials sodium chloride (NaCl) and lime (CaCO₃). Only ammonia (NH₃) is required as an auxiliary material. The Solvay method runs via the following partial reactions (1) through (4):

CaCO₃→CaO+CO₂ (1)

2NaCl+2CO₂+2NH₃+2H₂O→2NaHCO₃+2NH₄Cl (2)

2NaHCO₃→Na₂CO₃+H₂O+CO₂ (3)

CaO+2NH₄Cl→2NH₃+CaCl₂+H₂O (4)

CaCO₃+2NaCl→CaCl₂+Na₂CO₃ (5)

The overall reaction is summarized in equation (5).

The Solvay method relates to the industrial production of soda. The carbon dioxide consumed for the soda must be continuously replaced. For this purpose, lime (CaCO₃) is heated in a furnace, which decomposes into calcium oxide (CaO) above 900° C. In this process, which is also referred to as kilning lime (see equation (6)), CO₂ is released, which is in turn consumed in the production of soda. This procedure requires a very large amount of energy.

178.44 kJ+CaCO₃→CaO+CO₂ (6)

An overview of the method sequence is shown in FIG. 2.

In addition to the energy balance, it is seen as a disadvantage of the Solvay method in that CO₂ is released from lime, which was bound solidly in the lime up to this point. The soda (Na₂CO₃) is for instance employed in the glass production in large quantities. This CO₂, even if it is then provided bound in the form of soda (Na₂CO₃), then may reach the atmosphere during the glass production. It is another disadvantage of the Solvay method that lime is to be mined and has to be transported in large quantities. Besides the lime is often contaminated and thus has to be purified before it is then being used in the Solvay method in order to serve as CO₂-supplier.

Soda (Na₂CO₃) is also used in many other fields in addition to glass production (with silicon dioxide) and is a significant base material. In this context next, to the soda (Na₂CO₃) also other compounds, such as sodium hydrogen carbonate (NaHCO₃), are being employed. It is being used for the production of detergents, soaps, and foods, as well as for dyeing and bleaching. However, soda is also found in dyes, in catalysts, pesticides, and fertilizers, in cellulose or other materials, and for reducing aluminum oxide and silicon dioxide. Soda (Na₂CO₃) is being employed in the glass production in order to lower the melting point of the sand.

The object presents itself of providing a method which is capable of directly or indirectly binding larger quantities of CO₂.

This method is preferably to be applied in such a way that it runs especially favorably energetically. In addition, the method is to find broad acceptance to allow technical implementation on a broad basis. For this reason a material system is to be provided which, as needed, can be employed in the said field for different tasks and purposes.

### BRIEF DESCRIPTION OF THE DRAWINGS

Various aspects of the present invention are schematically illustrated in the drawing, which show:

FIG. 1: a diagram of a conventional sea water desalination plant, which may be used in connection with the present invention;

FIG. 2: the known Solvay method schematically;

FIG. 3: the method according to the present invention in a first embodiment schematically;

FIG. 4: a partial device which may be used in the method according to the present invention schematically;

FIG. 5: a further partial device which may be used in the method according to the present invention schematically;

FIG. 6: two further partial devices which may be used in the method according to the present invention schematically;

FIG. 7: an overall sequence according to the present invention schematically as a block diagram;

FIG. 8: an overall sequence according to the present invention schematically as a block diagram; and

FIG. 9: an alternative overall sequence according to the present invention schematically as a block diagram.

### DETAILED DESCRIPTION

The method according to the present invention is based on a novel concept which binds the CO₂ in sodium carbonate compounds, such as for instance sodium hydrogen carbonate (NaHCO₃) or soda (Na₂CO₃). The expression sodium carbonate compounds is herein used as generic term for sodium hydrogen carbonate (NaHCO₃), light soda ash or dense soda ash, soda with crystal water or without crystal water, calcinated soda.

Besides this, NH₄Cl may also be provided.

For this transformation/usage of CO₂ large amounts of salt water (e.g. in the form of sea water of brine) are being employed.

In the following, the individual starting materials and the products which may be used according to the present invention or which may arise in the scope of the corresponding method are listed.

### Sea Water:

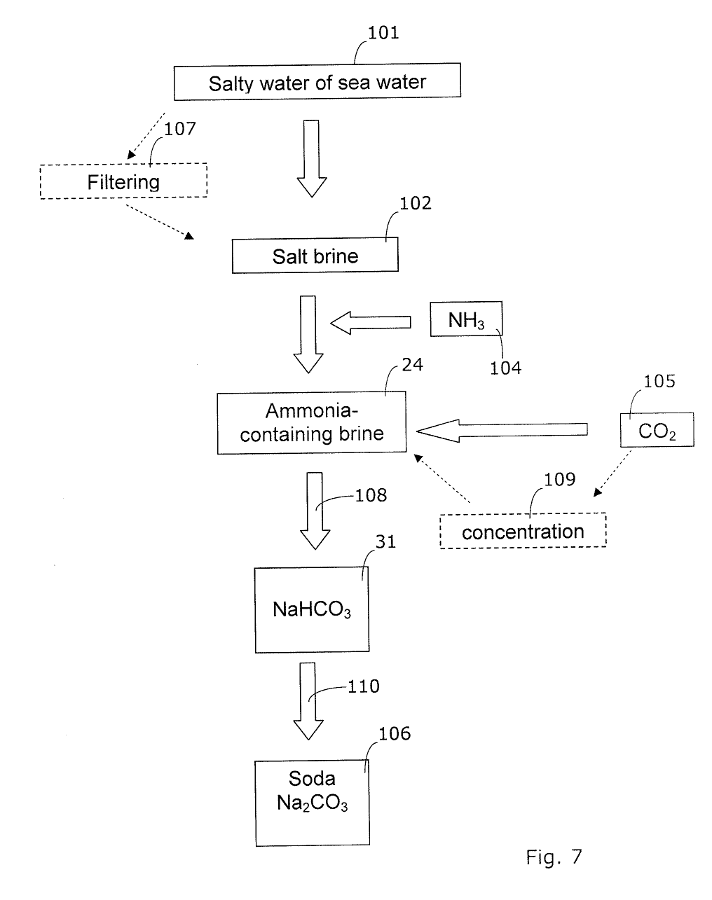

According to the present invention (as shown schematically in FIG. 7), sea water (salt water 101) is preferably used, to produce a concentrated aqueous sodium chloride solution therefrom. The concentrated aqueous sodium chloride solution produced from the sea water is referred to here as concentrated salt brine 102 for simplification.

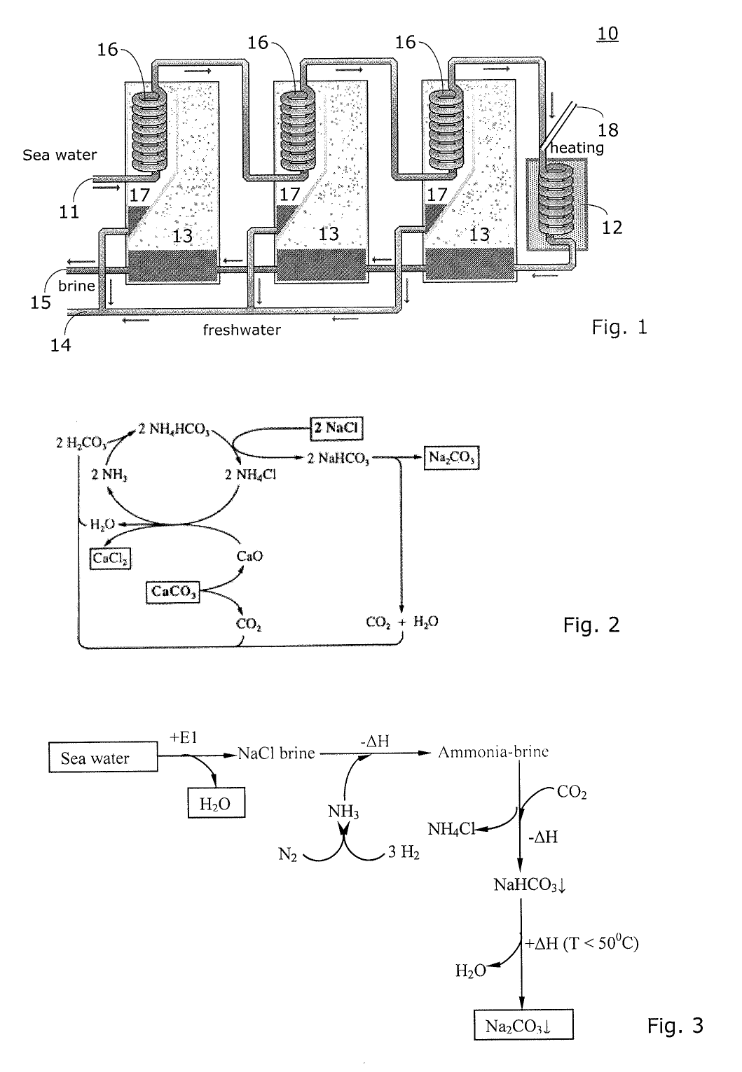

This concentrated salt brine 102 (preferably a saturated or nearly saturated brine) is preferably produced by an evaporation method (thermal distillation method). Multistage flash evaporation has especially proven itself. A corresponding plant 10 is shown in FIG. 1.

The concentrated salt brine 102 preferably has a salinity which is greater than 200 g/l, and is preferably greater than 300 g/l. It is especially advantageous to monitor the total salt content (salinity respectively the salt concentration) of the concentrated salt brine 102 by a conductivity measurement. The total salt content may also be monitored by measuring the pH value and the overall process may thus be controlled.

Multistage flash evaporation (MSF) is based on the evaporation and subsequent condensation of the resulting steam. In this method, the sea water (salt water 101) which has been supplied through a line 11 is heated in a heating area 12 (FIG. 1). However, the sea water previously runs through multiple cooling loops 16. The sea water is used therein to cool the water steam in low-pressure tanks 13, so that the water steam condenses out therein. After heating in the heating area 12 to temperatures above 100° C., the heated sea water is conducted into low-pressure tanks 13. Due to the low pressure, the water relaxes and evaporates therein. This steam then condenses on the corresponding cooling loop 16 and pure water (referred to here as freshwater) is obtained in an area 17. This water may be removed by a line 14. The concentrated salt brine 102 (NaCl-brine 102) is removed by a line 15.

So-called multiple effect distillation (MED) systems operate at temperatures from 63-80° C. The sea water is repeatedly (8-16 times) sprayed over heat exchanger pipes and evaporated with return of the condensation heat until all volatile substances have escaped.

Instead of a thermal method, a filtering method may also be used, which is based on reverse osmosis, for example. In simple terms, a membrane is therein used which separates a concentrated solution and a diluted solution from one another.

A solution is preferred which combines a multistage flash evaporation method with a filtering method.

In the meantime, there are devices and plants which consume between 3 and 10 kWh (corresponds to between 10.8 MJ and 36 MJ) of energy per m³ of sea water (e.g., reverse osmosis plants). In reverse osmosis plants, this energy is consumed in the form of current. For the thermal distillation methods, the energy consumption is between 3 and 6 kWh of current (corresponds to between 10.8 MJ and 21.6 MJ) and approximately 230 MJ heat energy per m³ of sea water in an MSF plant and between 2 and 4 kWh current (corresponds to between 7.2 MJ and 14.4 MJ) and approximately 200 MJ heat energy per m³ of sea water in an MED plant.

According to the present invention, the amount of energy E1 (FIG. 3) which is needed to operate the multistage flash evaporation method is at least partially provided by a power plant or a pyrolytic process. The corresponding energy component is identified here by E2. E2 equals E1 if all energy is provided by a power plant process or a pyrolytic process.

The concentrated salt brine 102 (NaCl-brine) may also be provided using solid salt (e.g., salt from a salt mine). For this purpose the soplid salt may be diluted in water. The water may be slightly heated to increase the solubility of the salt or to accelerate the solution process. References relating to the salinity also apply to concentrated salt brines 102 which are generated using solid salt.

A further energy component E3 may originate from chemical processes running in a cascade, which are explained in greater detail in the following, if the energy amount E2 is not sufficient. These chemical processes use the NaCl-brine 102 which has been provided from the sea water or from solid salt.

The NaCl-brine 102, which is made from sea water 101 or from solid salt, is preferably cleaned in order to remove contaminations (such as for instance calcium or magnesium). The contaminations can be removed by means of an optional filter step. This filter step 107 is depicted in FIG. 7 in a dashed form since it is optional. But chemical cleaning steps can also be carried out.

The processes according to the present invention are based on a similar approach as the Solvay method described at the beginning. This Solvay method is schematically illustrated in FIG. 2.

The basic outline of a first process according to the present invention is shown in FIG. 3. Both in FIG. 2 and also in FIG. 3, the educts (starting materials) and also the products are shown with borders, while intermediate products are shown without borders.

As already described, one starts in the method according to the present invention from sea water or from a solution (salt water 101) which is produced from solid salt in order to provide the NaCl-brine 102 (see FIGS. 3 and 7).

NaCl-brine 102 The method which is shown in FIG. 3 employs the energy E1 in order to provide sea water with a stronger concentration.

### Introduction of Ammonia (NH₃):

After the concentrated NaCl-brine 102 has been produced ammonia 104 (NH₃) is now employed.

According to the present invention, starting from the NaCl-brine 102, an ammonia-containing brine (also called ammonia brine) is produced in a downstream method. This is performed by introducing ammonia 104 (NH₃) into the concentrated salt brine 102 (NaCl-brine). In connection with the inventive method ammonia 104 plays the role of a catalyzer. It serves the purpose of maintaining a pH-environment in which predominantly hydrogen carbonate ions is present. These are necessary for the formation of the hardly soluble and due to this separable soda precursor sodium hydrogen carbonate 31 NaHCO₃.

The process of introducing ammonia 104 (NH₃) into the concentrated salt brine 102 (NaCl-brine), also called adsorption of ammonia 104 in brine 102, is preferably carried out in a saturation apparatus 20. This step is exothermic, i.e., energy is being released. Therefore, a −ΔH is shown in FIG. 3 next to this step.

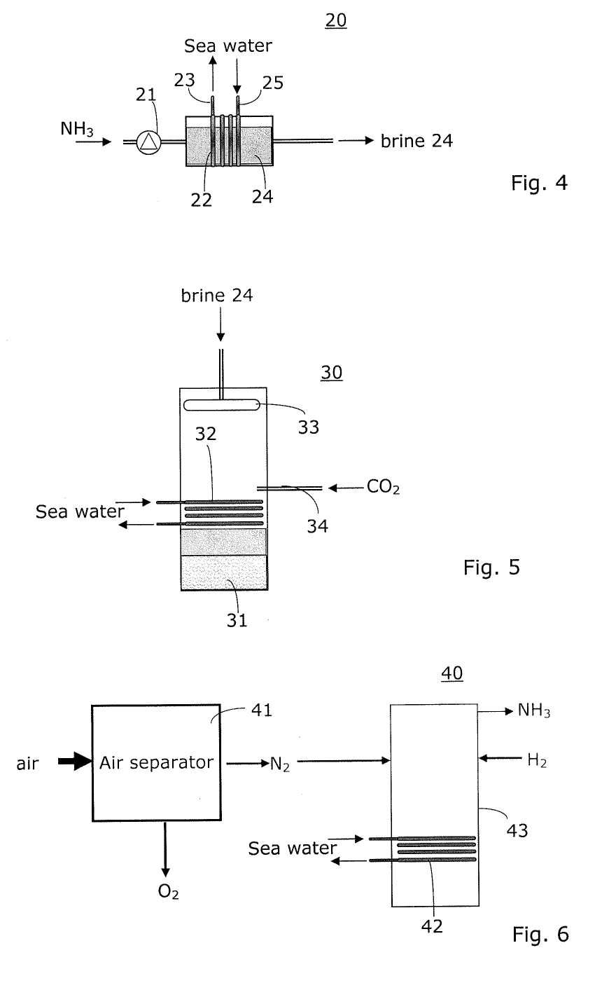

A corresponding saturation apparatus 20 is shown greatly simplified in FIG. 4. Using a pump 21 (e.g., a vacuum pump), the ammonia 104 is pumped or suctioned through the saturation apparatus 20 and the saturation apparatus 20 is accordingly cooled. A pipe cooler 22 having pipes which have cold water flowing through them is preferably used here. The water which is needed for the production of the NaCl-brine 102 may be guided through the pipe cooler 22. Due to the fact that this water takes on an increased temperature while circulating around or flowing through the saturation apparatus 20, the dissolving of the solid salt may be accelerated. Heat energy, herein referred to as E3*, is also transferred into the water. If one guides the water through the pipe cooler 22, then a cooling of the ammonia-containing brine 24 occurs, which in turn make it possible to solve notedly more CO₂ in this brine.

In a currently preferred embodiment of the present invention, the sea water is guided through these pipes of the pipe cooler 22, for example, directly after being removed from the ocean, as indicated in FIG. 4. Two advantages are achieved by this measure: firstly, the sea water is preheated, which reduces the energy needed for providing the brine 102 (if a thermal distillation method is used), because the sea water already has an elevated temperature; secondly, the ammonia-containing brine 24 is cooled, which subsequently allows significantly more CO₂ to be dissolved in this brine. The sea water has a higher temperature on the outlet side 23 after passing through the pipe cooler 22 than on the inlet side 25. Thus, heat energy, identified here as E3*, is transferred to the sea water. This energy E3* is a first component of the further energy component E3 which is needed for the thermal distillation method to provide the NaCl-brine.

Water steam condenses due to absorption in the saturation apparatus 20, because of which the solution is diluted. Therefore, the sodium chloride of the brine 24 does not precipitate in spite of corresponding reduction of the solubility upon introduction of the ammonia.

In a preferred embodiment, to reduce the energy needed E1 for providing the brine 102, the outlet side 23 of the pipe cooler 22 may be connected directly to the inlet side 11 of the device 10, for example. Alternatively, the pipe cooler 22 may have a heat transfer medium flowing through it, which transports heat through pipes to the heater 12, to support the heating of the sea water here. In this case, sea water does not flow through the pipe cooler 22.

Gaseous CO₂ is now introduced into the ammonia-containing brine 24 (FIG. 5). This may be performed by conducting the ammonia brine 24 for instance from above into a device 30 (e.g., in the form of a packed tower or a evaporation system), while CO₂ is simultaneously pumped or blown in from below (see FIG. 5). The ammonia-containing brine 24 is preferably introduced into the device 30 by a distributor head 33 or through injection nozzles.

This process is also exothermic and the sodium hydrogen carbonate (NaHCO₃) 31 precipitates while developing heat. The sodium hydrogen carbonate precipitates since it is of lower solubility than the ammonia chloride produced. The sodium hydrogen carbonate (NaHCO₃) 31 is shown very schematically in the lower area of the device 30 in FIG. 5. In an evaporation system for instance the sodium hydrogen carbonate (NaHCO₃) 31 can be separated from the liquid since during the evaporation sodium hydrogen carbonate (NaHCO₃) 31 is left behind as solid compound.

The process according to the invention may preferably be controlled so that the sodium hydrogen carbonate (NaHCO₃) 31 has a concentration in the aqueous solution which is above 50 g/l and preferably above 100 g/l. A process where the concentration is kept by a control near the saturation is particularly preferred.

It is optional to employ centrifuges in order to separate the water portion or solution portion from the sodium hydrogen carbonate (NaHCO₃) 31.

Preferably, the CO₂ stems from the exhaust gas of a power plant or pyrolysis process, respectively from an oxidation or reduction process. The CO₂ should be chemically as clean as possible and preferably should have a concentration of at least 35% in the gas stream. Gas streams are better suited which have a CO₂ 105 (FIG. 7) content which is above 40%. A concentration step can be carried out, which is depicted in FIG. 7 as block 109, if the CO₂ concentration should not be sufficient. This step 109 is optional, but it ensures that the inventive method is particularly efficient if the above-mentioned CO₂ concentration is kept.

The usage/storage of the CO₂ 105 in the form of a sodium carbonate compound, e.g. soda 106, or sodium hydrogen carbonate 31 (NaHCO₃) as a pre-cursor of soda 106, is herein referred to as efficient and very environmentally friendly CO₂-binding possibility. The respective process steps can for instance be carried out in the apparatus 20, 30, 40.

Because in the ammonia-containing brine 24 the solubility of CO₂ 105 is reduced with increasing temperature, cooling units 32 are to be used to dissipate the heat (−ΔH in FIG. 3) arising during the exothermic reaction. This heat energy is referred to as E3**. This cooling unit 32 may also in turn be cooled by sea water, as indicated in FIG. 5. The sea water is thus (further) preheated, before it is finally brought to a temperature above 100° C. in the heater 12 (see FIG. 1). Alternatively, a heat transfer medium may flow through the cooling unit 32, which transports heat through pipes to the heater 12 to support the heating of the sea water here. In this case, the sea water does not flow through the cooling unit 32.

The cooling units 22 and 32 are preferably connected in series and have sea water flowing through them in sequence, before the heated sea water reaches the device 10 e.g. via the inlet side 11.

If the sea water is heated by the waste heat E3* and E3** of the exothermic process steps, the cooling performance of the cooling loops 16 is reduced. These cooling loops 16 operate best at sea water temperatures which are below 50° C. and preferably below 30° C. Therefore, in an alternative embodiment, the water preheated by the waste heat E3* and E3** may be conducted directly via a bypass line 18 into the heater 12, while cooler sea water is guided through the cooling loops 16. The bypass line 18 is indicated as rudimentarily in FIG. 1. The cooler sea water is mixed in this embodiment with the preheated sea water and then brought to above 100° C. before it reaches the low-pressure tank 13.

The cooling appliances 22 and 32 can obviously be connected in series when no sea water desalination is carried out but when water is to be heated in order for instance to better or more quickly solve solid salt in water.

According to the present invention, ammonia 104 (NH₃) is used, as noted. The ammonia 104 is not used up but in a preferred embodiment it is almost entirely recycled. There are various ways of providing the ammonia. The following approaches are especially preferred.

The ammonia 104 can either be an ingredient which is obtained from livestock or agriculture (e.g. from pig slurry), or ammonia 104 can be gained from the bio gas appliance or preferably from the Haber-Bosch-process (see below). Alternatively, ammonia 104 may also be supplied.

### Sodium Hydrogen Carbonate (NaHCO₃):

The sodium hydrogen carbonate 31 (NaHCO₃) may be obtained from the ammonia-containing brine 24 by means of filtering or precipitation. The arrow 108 in FIG. 7 shows the filtering or precipitation step.

The sodium hydrogen carbonate 31 (NaHCO₃) may be stored to bond the CO₂ 105 permanently. However, sodium hydrogen carbonate may also be used in chemical processes in which as little CO₂ as possible arises or where the CO₂ which is released is caught and re-used again.

For this reason it is particularly preferred to erect the apparatus for further processing and usage of the sodium hydrogen carbonate 31 (NaHCO₃) in the immediate vicinity of the inventive apparatus.

### Sodium Carbonate (NaCO₃/Soda):

The sodium hydrogen carbonate 31 (NaHCO₃) may be dried by slow heating and thus provided as a powder (calcinated soda=water-free sodium carbonate: Na₂CO₃). This procedure is schematically shown in FIG. 3 and it is indicated in FIG. 7 by the reference number 110. The freshwater arising during the heating is preferably captured. The heating is preferably performed at a temperature T≦50° C., to prevent the release of CO₂ entirely, or to reduce the quantity of released CO₂.

Sodium carbonate 106 can also be produced by means of calcination of the sodium hydrogen carbonate 31 (NaHCO₃) at temperatures between 124° C. and 250° C. and by driving out the water. Raw soda is thus created. This raw soda may be diluted in water and then filtered. In this way one may obtain heavy (dense) soda.

Sodium carbonate is the salt of a weak acid and reacts with stronger acids by releasing CO₂. Sodium carbonate is solved in water developing strong heat (hydration heat), max. 21.6 g/100 ml by forming a strong alkaline solution.

Sodium carbonate thus can not only be employed in order to store, respectively bind CO₂, but it can also be used as energy carrier. Two ways for storing energy offer themselves.

Firstly, the sodium carbonate can be employed in a system large amounts of the CO₂ gas are released when small amounts of acid (e.g., HCl) are added. The releasing of gas can be used in order to drive a turbine or a generator which generates electric energy. Preferably a closed system is employed, where the CO₂ gas is again reintroduced into the ammonia-containing brine 24, in order not to release the CO₂ gas into the environment, or the CO₂ gas is stored in bottles or tanks and sold.

Secondly, the sodium carbonate can be employed in a system in order to, for instance in the vicinity of a power plant or an industrial process temporarily store heat energy. The sodium carbonate 106 can be created in solid form in the vicinity of a power plant in order to release energy upon need when binding it with water. But sodium carbonate 106 can also be transported to any other place. There heat can be released if needed by binding with water. The sodium carbonate or sodium hydrogen carbonate may also be melted by applying heat in order to store this heat energy in the melt.

Since in today's power plant processes only part of the heat energy is used due to corresponding coupling a large portion of the heat energy is until now not reasonably used. Sodium carbonate 106 may be employed in order to chemically bind and store this heat energy.

The sodium carbonate 106 may be stored in order to bond the CO₂ permanently. Calcinated soda (water-free Na₂CO₃) may be stored relatively easily in dry rooms or desert regions. Preferably sodium carbonate 106 is stored in closed rooms, caverns, tunnels or in (steel) containers with lid in order to prevent that soda dust is being released.

Sodium carbonate has the tendency to harden when being stored. For this reason, a bit of sodium hydrogen carbonate (<10% volume percent) is added, according to the present invention.

Typically the sodium carbonate 106 has a density of about 510 to 620 kg/m³, if it is being produced according to the inventive method. In order to be able to better store or transport it, or in order to increase the energy content, the sodium carbonate 106 may be transformed in to heavy sodium carbonate by means of heating (preferably by de-hydration in a vacuum tower or furnace) and/or by means of a pressure treatment (e.g. by using pressure barrels). Heavy sodium carbonate has a density between 960 and 1060 kg/m³.

If soda 106 come in contact with humidity the monohydrate Na₂CO₃*H₂O is generated due to the uptake of water. In this case the CO₂ continues to be bound.

However, sodium carbonate 106 may also be used in chemical processes in which as little as possible CO₂ arises, or where the CO₂ which is released is caught up and re-used again.

For this reason it is particularly preferred to erect the apparatus for further processing and usage of the soda 106 (e.g. a glass factory or a plant for aluminum production, or a plant for silicon production) in the immediate vicinity of the inventive apparatus.

### Obtaining Ammonia NH₃ According to the Haber-Bosch Method:

Ammonia 104 may be produced by directly combining nitrogen and hydrogen according to equation (7):

N₂+3H₂←→2NH₃+92 kJ mol⁻¹ (7)

This approach is schematically shown in FIG. 3. The ammonia synthesis according to equation (7) is exothermic (reaction enthalpy −92.28 kJ/mol). This is an equilibrium reaction which runs with volume reduction. The nitrogen may be provided according to the Linde method, for example, in which the oxygen and nitrogen are separated from the ambient air, as shown schematically in FIG. 6 by the method block 41. The method block 41 may be part of a plant 40 which is designed to provide ammonia 104 (NH₃).

The hydrogen may be produced conventionally from methane (CH₄), for example. This methane may be produced from a pyrolysis method, or the methane may be produced from ammonium chloride (NH₄Cl). This NH₄Cl arises in the method according to the present invention as an (intermediate) product, as indicated in FIG. 3. However, NH₄Cl may also be used to bond further CO₂.

Because the NH₃ synthesis according to (7) is exothermic and runs with volume reduction, there is a dependency of the yield of NH₃ 104 of pressure and temperature. The exothermic reaction (7) shifts with increasing temperature toward the side of the starting products, i.e., at higher temperature, the yield of NH₃ 104 is lower. Reactions with volume reduction are displaced upon pressure increase toward the side of the final products, i.e., to higher yields of NH₃ 104 here. Therefore, according to the present invention, the NH₃ synthesis is preferably performed in a NH₃ synthesis reactor, e.g., in the form of a cooled pressurized vessel 43. Cooling using sea water is again especially preferred in the present context. A cooling unit 42 may also be used here, which is in turn part of a series circuit of sea water-cooled cooling units 22, 32, and 42.

The NH₃ synthesis according to (7) provides a part of the energy which is necessary for operating the thermal distillation method to provide the NaCl-brine 102 from sea water. This energy contribution is identified as E3***.

Alternatively, cooling using a heat transfer medium may also be performed here, as described above, to convey the energy E3*** to the heater 12.

If desired, urea may also be produced from the ammonia (NH₃) according to following equation (8) if needed (this herein serves as a further CO₂ binding possibility):

2NH₃+CO₂→(NH₂)2CO+H₂O (8)

This method (8) may be used if, for example, urea is needed in the power plant or pyrolysis process running in parallel to remove soot particles or other pollutants from the exhaust gases (flue gas). The material group or family which is employed has the advantage that it can be very flexibly and relatively easily employed for very different purposes. One may for instance, as described, remove the soot particles or other contaminants from the flue gas, in addition to transforming CO₂, which is for instance present in the flue gas of a power plant, into sodium carbonate compound(s). For this it is not necessary to transport other chemical compounds with the respective logistic effort, but the compounds and material groups or -families (e.g. urea) can be employed which are present on site.

However, the urea may also be used as an energy store, because urea may be stored and/or transported well and without problems. The urea may also be used as a fertilizer raw material.

### Ammonium Chloride:

Ammonium chloride (NH₄Cl) arises as an (intermediate) product in the method according to the present invention, as indicated in FIGS. 3, 8 and 9.

Ammonium chloride sublimates upon heating and decomposes completely into ammonia (NH₃) and hydrogen chloride (HCl) from 335° C., as shown in equation (9):

H₂O+2NH₄Cl→2NH₃+HCl (9)

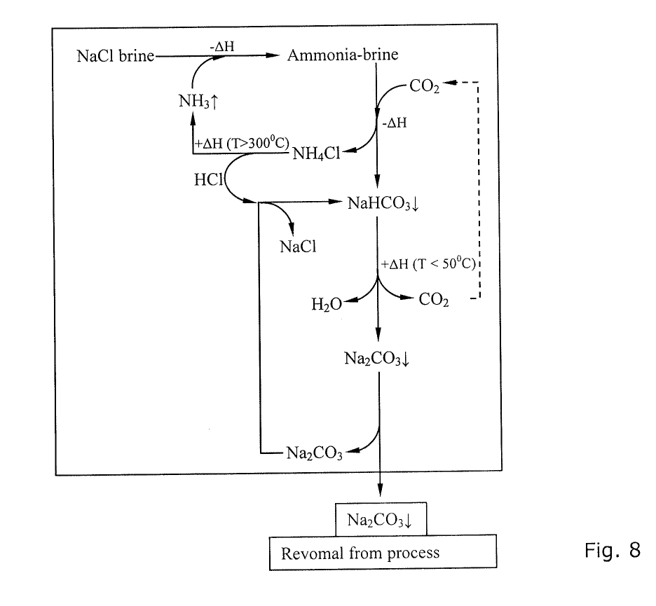

This process (9) may be used to (re-)obtain ammonia (NH₃). A respective schematic sequence is shown in FIG. 8.

Hydrogen chloride (HCl) is a valuable raw material for many industrial processes. If sodium (Na) is available, NaCl may optionally be produced again.

However, ammonia (NH₃) may also be (re-)obtained via the following optional path (10). NaCl is also obtained again in this process:

NH₄Cl+NaOH→NH₃+NaCl+H₂O (10)

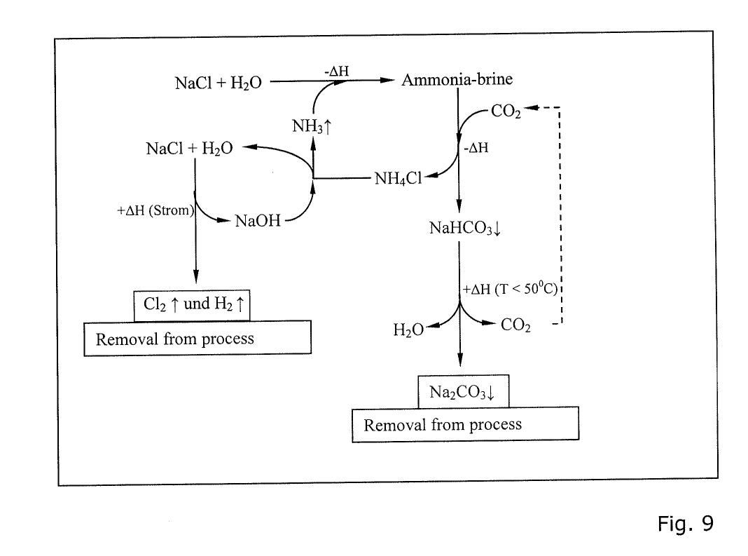

Here one may preferably add a down-stream process that turns NaCl plus water into chloric gas and hydrogen gas, as shown in FIG. 9. This transformation occurs due to the applying of current and NaOH is generated which may be kept in a circle. Hydrogen gas is an energy carrier that can e.g. be stored, transported or employed in a fuel cell.

Ammonium chloride is currently used, inter alia, in the production of freezing mixture, in dyeing and tanning plants. It is also used in tinning, galvanization, or soldering, because it has the capability of forming volatile chlorides with metal oxides and thus cleaning the metal surface.

However, ammonium sulfide (NH₄HSO₄) may also be produced from the ammonium chloride, as described, for example, in the Mexican patent document with publication number MXNL03000042 and the title “PROCESS FOR TRANSFORMING AN AMMONIUM CHLORIDE SOLUTION GENERATED BY THE SOLVAY PROCESS INTO AMMONIUM SULPHATE.”

The ammonium chloride may also be used as a hydrogen store, however.

Hydrogen may be cleaved from the ammonium chloride and this hydrogen may be converted to methane and water with CO₂ according to the following reaction equation (11). The method (11) runs at approximately 1250° C. and is exothermic (releases energy). The corresponding energy amount which is released in (11) may be used as energy contribution E3**** in the method for producing the NaCl-brine.

CO₂+3H₂→CH₄+H₂O

This method (11) is especially preferred in the present case, because on one hand CO₂ is bound and on the other hand methane may be provided. The methane is a valuable energy carrier, which may be stored and transported. It is especially advantageous if, in the scope of the present invention, the methane is used to provide at least a part of the energy quantity E1 needed for producing the NaCl-brine.

However, the methane may also be converted into longer-chain hydrocarbons or liquefied.

This means it is possible to provide the ammonium chloride as an (intermediate) product for further important processes, or to convert the ammonium chloride into corresponding products.

### Sodium Hydroxide (NaOH) (Caustic Soda):

NaOH is a white hygroscopic solid material. It dissolves in water by releasing a large amount of heat to form caustic soda which reacts highly alkaline (pH about 14 at c=1 mol/l).

NaOH may be produced for instance according to the following process (12):

Na₂CO₃+Ca(OH)₂→2NaOH+CaCO₃ (12)

Sodium hydroxide is readily soluble in water. The sodium hydroxide is another material of the inventive material group or family since it can be easily produced from soda.

Sodium hydroxide, however, may also be turned in sodium carbonate (heavy, dense soda) by adding CO₂, as shown in (13):

NaOH+CO₂→Na₂CO₃.H₂O (13)

The sodium hydroxide thus can also be employed for storing or binding CO₂. After the evaporation of caustic soda again solid sodium hydroxide remains, as shown in equation (14):

NaOH(aq.)→NaOH(s) (14)

The sodium hydroxide is according to the invention suited a material for storing energy. Sodium hydroxide in aqueous solution (caustic soda) may be transformed into solid sodium hydroxide by means of heating, respectively by applying heat energy. Large amounts of energy are stored in solid sodium hydroxide. To a large extend this energy can again be released if needed by mixing sodium hydroxide with water. Thereby heat is generated.

The sodium hydroxide thus can be employed in the vicinity of a power plant for instance for temporarily storing energy. However, sodium hydroxide can also produced in solid form in the vicinity of a power plant to be transported to any other place. There it can release heat by blinding with water, if needed.

Since in today's power plant processes only part of the heat energy is used due to corresponding coupling a large portion of the heat energy is until now not reasonably used. Sodium hydrocide may be employed in order to chemically bind and store this heat energy.

### Modified Soda/Potash Digestion:

NaOH or also a strong soda-potash solution dissolves silicates, Al₂O₃, or SiO₂, in which it is hydrolyzed to form low-linked silicates (primarily ring and chain silicates [SiO₃]ₙ²ⁿ⁻).

The soda 106 may be used according to the present invention in a modified soda/potash digestion, e.g., in the aluminum production for lowering the melting point (fluorine-free without cryolite), or in the production of silicon from sand, where the soda 106 lowers the melting point of sand. This silicon made in turn can be used to react exotheimically with the carbon from the CO₂ to form silicon carbide (SiC).

### Cooling Devices:

Various cooling devices are discussed in the present context. It is obvious that there are various ways of implementing such cooling devices.

### Freshwater:

A further essential aspect of the present invention is that when binding CO₂ originating from a combustion, pyrolysis, or another industrial process, in addition to the valuable soda or the sodium hydrogen carbonate 31, drinking water/freshwater also results. This water is more or less a waste product and may be used for the drinking water supply.

If one wishes to make use of further measures for actual CO₂ reduction, the water may be used for watering plantations and new plantings. “Living biomass” is thus provided, which contributes to binding further CO₂ through photosynthesis. An actual “avalanche effect” thus arises through the “watering” of desert areas.

### AlON® Powders/Construction Materials:

Important construction materials may be manufactured from the reaction products which are provided according to the present invention. Ceramic AlON powder is to be cited as an example. This powder may be produced by milling a mixture made of aluminum and aluminum oxide in a nitrogen atmosphere, for example. This powder is then heated in an inert gas atmosphere to produce a homogeneous aluminum oxynitride material therefrom. Details in this regard may be inferred from U.S. Pat. No. 6,955,798. The required aluminum may be produced using the soda 106 according to the present invention in a modified soda/potash digestion.

### Sodium Carbonate Solution as CO₂-Store:

It is regarded to be a further advantage of the invention that a sodium carbonate solution can be employed in order to bind CO₂ by means of chemical absorption. Preferably one works at medium to low CO₂ partial pressures.

In a particularly preferred embodiment a sodium carbonate solution is provided in a by-pass tank so that in case when problems occur in connection with the chemical CO₂ binding procedure the CO₂ can be transformed into a sodium carbonate compound in order to quasi provide an intermediate storage of the CO₂ gas stream without having to release CO₂ into the environment. The sodium carbonate solution is this case quasi acts as a temporary chemical buffer for the intermediate storage of certain amounts of CO₂ gas.

### Sodium Carbonate Used for Flue Gas Cleaning:

The sodium carbonate, preferably the sodium hydrogen carbonate, can be employed for the cleaning of flue gas, as follows. Ground or powdery sodium hydrogen carbonate is blown in the flue gas to be cleaned. Such a cleaning step is preferably carried out after the flue ash (soot) has been removed from the flue gas and prior to having transformed the CO₂, in accordance with the invention, into a sodium carbonate compound.

The injection of the sodium hydrogen carbonate leads to a neutralization of the acidic flue gas components (such as hydrogen chloride (HCl), sulfur dioxide (SO₂) and hydrofluoric acid (HF)). An example is presented in the following equation (15):

NaHCO₃+HCl→NaCl+H₂O+CO₂ (15)

In this step so-called sodium compounds are generated such as sodium chloride (NaCl), sodium sulphate (Na₂SO₄), sodium fluoride (NaF) and in part also small amounts sodium carbonate (Na₂CO₃). The CO₂ gas which develops in this step leads to an increasing of the CO₂ portion in the flue gas stream and is particularly advantageous, since the transformation to a sodium carbonate composition is especially efficient at high CO₂ concentrations.

The injection of the sodium hydrogen carbonate has the advantage that heavy metals are absorbed, too.

It is particularly advantageous to inject 0.5-3 weight percent sodium hydrogen carbonate in relation to the fossil combustible which is being combusted in a fossil power plant. That is for 100 kg anthracite coal for instance between 0.5 and 3 kg of sodium hydrogen carbonate is injected into the flue gas. It has proved itself particularly well to inject from 2.1 to 3 weight percent sodium hydrogen carbonate.

Sodium Hydrogen Carbonate and/or Soda as Heat- or Energy Storage:

Sodium hydrogen carbonate (NaHCO₃) but also (crystal)soda (Na₂CO₃.10H₂O) may be used as chemical heat storage (latent heat storage). Due to the in feeding/injection of heat energy (e.g. the waste heat of a power plant or a heating system) the water content (e.g. in the form of crystal water) can be released.

Sodium acetate (Na(CH₃COO)) may be used instead of the sodium hydrogen carbonate or the (crystal)soda. Na(CH₃COO).3H₂O trihydrate is suited as latent heat storage. Sodium carbonate (Na₂CO₃) or sodium hydrogen carbonate (NaHCO₃) can be converted to sodium acetate.

If later on water is added to the chemical heat storage the stored heat is released. The process which was described is based on a reversible process.

Sodium carbonate, for instance, dilutes in water while developing strong heat (hydratation heat) of max 21.6 g/100 ml and while forming a strong alkaline solution.

Corresponding chemical heat storages can be realized which release heat when needed by adding water.

Alternatively heat can be stored in molten salts (e.g. molten soda). A corresponding heat storage has to be heat insulated in order not to give away heat to the outside. During the solidifying heat is again released.

Sodium carbonate (Na₂CO₃) for instance is suited as heat storage since the sodium carbonate is melting at increased temperatures or when applying alternating current.

The method according to the present invention for binding gaseous CO₂ comprises the following steps in summary:
a. Providing salty water 101, preferably sea water,
b. Producing a concentrated salt brine 102 having elevated salt concentration from the salty water,
c. Providing ammonia 104 (NH₃),
d. Providing CO₂ 105 from an oxidation or reduction process,
e. Introducing the ammonia 104 (NH₃) into the concentrated salt brine 102 to obtain an ammonia-containing brine 24, and introducing the CO₂ 105,
f. Separating sodium carbonate compound, preferably sodium hydrogen carbonate 31 (NaHCO₃), from the ammonia-containing brine 24,
h. optionally capturing and providing freshwater which arises upon heating of the salt-containing water 101, and
i. optionally converting the sodium carbonate compound into lighter or heavier soda 106.

The conversion of light soda into a heavier (more dense) form of soda requires energy. Quite often there is energy available, which is not used efficiently, in the neighborhood of a power plant or industrial process. The excess heat energy of a fossil power plant thus can be used in order to refine the CO₂-binding sodium carbonate compound.

What is claimed is:

1. A method for binding gaseous CO₂, characterized by the following steps:
a. providing salt-containing water and,
producing a concentrated salt brine having elevated salt concentration from the salt-containing water while supplying energy,
b. providing ammonia (NH₃),
c. providing CO₂ from an oxidation or reduction process,
d. introducing the ammonia (NH₃) into the concentrated salt brine to obtain an ammonia-containing brine and introducing the CO₂,
e. separating a sodium carbonate compound from the ammonia-containing brine.

2. The method according to claim 1, wherein the sodium carbonate compound is sodium hydrogen carbonate (NaHCO₃) and wherein the sodium hydrogen carbonate (NaHCO₃) is dried by slow heating and thus provided as a powder freshwater arising upon heating is captured, and the heating is performed at a temperature T≦50° C. to prevent the release of CO₂ entirely, or to reduce the quantity of released CO₂.

3. The method according to claim 2, wherein the CO₂ arising upon heating is reintroduced into the concentrated salt brine.

4. The method according to claim 2, wherein the slow heating is performed in a rotary kiln.

5. The method according to claim 1, wherein, the concentrated salt brine is produced by:
the heating of the salty water, or
the membrane filtering,
and wherein the concentrated salt brine is saturated with salt.

6. The method according to claim 1, wherein saturation of the concentrated salt brine with ammonia is achieved by introducing ammonia (NH₃).

7. The method according to claim 1, wherein the sodium hydrogen carbonate (NaHCO₃) precipitates as a solid.

8. The method according to claim 1, wherein the concentrated salt brine has a respective salinity greater than 200 g/l.

9. The method according to claim 1, wherein the total salt content (salinity) of the concentrated salt brine is monitored by a conductivity measurement.

10. The method according to claim 1, wherein the introduction of CO₂ into the concentrated salt brine is monitored and controlled by measuring the pH value.

11. The method according to claim 1, wherein the concentrated salt brine is cooled before or during step d. to increase the solubility of CO₂ by conducting sea water through cooling pipes.

12. The method according to claim 1, wherein the concentrated salt brine is put under pressure in step d. to increase the solubility of CO₂.

13. The method according to claim 1, wherein at least a part of the ammonia (NH₃) is introduced into the concentrated salt brine in step d. before the CO₂ is introduced into the concentrated salt brine to thus avoid a reaction to form hydrochloric acid.

14. The method according to claim 2, wherein the formation of sodium hydrogen carbonate (NaHCO₃) runs exothermically.

15. The method according to claim 1, wherein an exothermic absorption of the ammonia (NH₃) into the concentrated salt brine occurs in step d.

16. The method according to claim 1, wherein the energy supply in step a. is performed by coupling to a power plant process.

17. The method according to claim 1, wherein the energy supply in step a. is performed by coupling to a pyrolysis process, wherein power or gas from the pyrolysis is being used to heat the salt-containing water.

18. The method according to claim 1, wherein the CO₂ in step d. originates from the waste gases of a power plant process and/or pyrolysis process and wherein the CO₂ has a concentration of at least 35% in the flue gas.

19. The method according claim 1, wherein the sodium carbonate compound is employed in order to bind acidic flue gas components.

20. A device comprising:
a plant for providing a concentrated salt brine with elevated salinity,
a device for receiving the concentrated salt brine further comprising means for introducing ammonia (NH₃) to be able to produce an ammonia-containing brine,
means for receiving the ammonia-containing brine,
means for removing CO₂ from an oxidation or reduction process, and for introducing the CO₂ into the ammonia-containing brine, and
means for separating sodium carbonate from the ammonia-containing brine.

21. The device according to claim 20, further comprising:
a multistage flash evaporation device (MSF), and/or
a multiple effect distillation device (MED), and/or
a filter device.

22. The device according to 20, wherein the device for receiving the concentrated salt brine is a saturation apparatus.

23. The device according to claim 20, wherein the means for receiving the ammonia-containing brine is one or more pipe cooler.

24. The device according to claim 22, wherein multiple pipe coolers are situated one after another in series and have sea water flowing through them.

25. The device according to one of claim, wherein at least a part of the energy supply for the salt plant is provided by a power plant.

26. The device according to one of claim 20, having means for separating oxygen and nitrogen from ambient air.

27. The device according to claim 26, having a plant, which is fed with nitrogen and with hydrogen to provide ammonia (NH₃).
